(19) United States
(12) Patent Application Publication
(10) Pub. No.: US 2022/0263219 A1
(43) Pub. Date: Aug. 18, 2022

(54) LAMINATED GLASS ANTENNA STRUCTURE

(71) Applicants: HYUNDAI MOTOR COMPANY, Seoul (KR); KIA CORPORATION, Seoul (KR); HONGIK UNIVERSITY INDUSTRY-ACADEMIA COOPERATION FOUNDATION, Seoul (KR)

(72) Inventors: Nak Kyoung Kong, Seongnam-si (KR); Dae Hee Lee, Incheon (KR); Ki Hong Lee, Seoul (KR); Jong Min Park, Seoul (KR); Ho Sung Choo, Seoul (KR); Do Young Jang, Seoul (KR); Sang Woon Youn, Anyang-si (KR)

(73) Assignees: HYUNDAI MOTOR COMPANY, Seoul (KR); KIA CORPORATION, Seoul (KR); HONGIK UNIVERSITY INDUSTRY-ACADEMIA COOPERATION FOUNDATION, Seoul (KR)

(21) Appl. No.: 17/673,050

(22) Filed: Feb. 16, 2022

(30) Foreign Application Priority Data
Feb. 18, 2021 (KR) 10-2021-0021957

(51) Int. Cl. H01Q 1/12; B32B 17/10; H01Q 9/04

(52) U.S. Cl. CPC H01Q 1/1271; B32B 17/10376; B32B 17/10036; H01Q 9/0407; B32B 2307/732; B32B 2457/00; B32B 2605/006; B32B 2250/05; B32B 2307/202; B32B 2250/40

(57) ABSTRACT

A laminated glass antenna structure includes an upper glass located at the outermost position of a vehicle, a patch radiation unit located in at least a portion of the rear surface of the upper glass, and a lower glass located on the rear surface of the patch radiation unit. In particular, the patch radiation unit includes a strip line located in a height direction of the patch radiation unit, at least one extension line extending in the lateral direction of the strip line, and a patch element located at the end of the extension line.

### CROSS-REFERENCE TO RELATED APPLICATION

This application claims under 35 U.S.C. § 119(a) the benefit of and priority to Korean Patent Application No. 10-2021-0021957, filed on Feb. 18, 2021, the entire contents of which are incorporated herein by reference.

### FIELD

The present disclosure relates to a laminated glass antenna structure for a vehicle.

### BACKGROUND

The statements in this section merely provide background information related to the present disclosure and may not constitute prior art.

As recent demand for and the actual number of automobiles increases, the number of traffic accidents increases in proportion thereto.

It has been found that driver negligence is a major cause of such traffic accidents, and WAVE (wireless access in vehicular environments) communication is emerging as a way of reducing traffic accidents caused by driver negligence. The WAVE is regarded as very important in vehicle-to-vehicle high-speed communication (V2V) and vehicle-infrastructure communication (V2I) as next-generation communication environments for vehicles.

Moreover, 5G communication technology in vehicles has been receiving attention as data collection technology used for improving the driving environment by collecting a large amount of data such as driving information of other vehicles, surrounding traffic information, pedestrian information, and the like. As such, a glass antenna technique for printing an antenna pattern on a vehicle glass is used to minimize the amount of additional space for an antenna for communication to be mounted on a vehicle and to provide a good aesthetic appearance to the vehicle. However, we have found that currently available glass antennas are designed for AM and FM reception, so new antenna design technology for the 5G band is required.

Experiments for applying the WAVE communication technology to vehicles and experiments for implementing the WAVE communication technology in large vehicles such as buses and the like on highways are being actively conducted. In addition, such WAVE technology may be implemented as a shark antenna installed on a general passenger car, but such an antenna is installed outside the vehicle, so the installation work is difficult and the installation structure is complicated.

### SUMMARY OF THE DISCLOSURE

The present disclosure has been made keeping in mind the problems encountered in the related art, and the present disclosure provides a laminated glass antenna structure configured such that a patch radiation unit is located in a portion between the upper glass and the lower glass.

Another form of the present disclosure provides a laminated glass antenna structure including a single patch radiation unit having an optimal size.

The present disclosure is not limited to the foregoing, and other forms of the present disclosure not mentioned herein should be able to be understood by the following description and to be appreciated more clearly by the embodiments of the present disclosure.

An embodiment of the present disclosure provides a laminated glass antenna structure including: an upper glass located at the outermost position of a vehicle, a patch radiation unit located in at least a portion of the rear surface of the upper glass, and a lower glass located on the rear surface of the patch radiation unit, the patch radiation unit including a strip line located in a height direction, at least one extension line extending in a lateral direction of the strip line, and a patch element located at an end of the extension line.

Also, the patch element may have a quadrangular shape, each side of which is 1.4 mm to 2.6 mm long.

Also, the strip line may have a width of 0.1 mm to 0.9 mm.

Also, the extension line may be formed to a length of 2.4 mm to 3.6 mm from the strip line.

Also, the laminated glass antenna structure may further include a ground on the rear surface of the lower glass.

Also, the upper glass may have a thickness of 1.5 mm to 2.7 mm.

Also, the lower glass may have a thickness of 0.3 mm to 1.1 mm.

Also, the patch radiation unit may be provided in four rows in a width direction.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The above and other features of the present disclosure are now described in detail with reference to certain exemplary embodiments thereof illustrated in the accompanying drawings, which are given hereinbelow by way of illustration only, and thus are not limitative of the present disclosure, and wherein:

FIG. 1 illustrates a cross-sectional view of a laminated glass according to an embodiment of the present disclosure;

FIG. 2 illustrates a perspective view of a laminated glass antenna structure according to an embodiment of the present disclosure;

FIG. 3 illustrates an enlarged view of a single patch radiation unit according to an embodiment of the present disclosure;

FIG. 4 illustrates the reflection coefficient and efficiency of the glass including the patch radiation unit according to an embodiment of the present disclosure;

FIG. 5A illustrates a laminated glass antenna structure according to an embodiment of the present disclosure;

FIG. 5B illustrates a radiation pattern through the laminated glass antenna structure in FIG. 5A according to an embodiment of the present disclosure; and

FIG. 6 illustrates a radiation pattern based on the patch radiation unit array of the laminated glass antenna structure according to an embodiment of the present disclosure.

The drawings described herein are for illustration purposes only and are not intended to limit the scope of the present disclosure in any way.

### DETAILED DESCRIPTION

Hereinafter, a detailed description is given of embodiments of the present disclosure with reference to the accompanying drawings. The embodiments of the present disclosure may be modified in various forms, and are not to be construed as limiting the scope of the present disclosure. The present embodiments are provided to more completely explain the present disclosure to those having ordinary skill in the art.

Also, terms such as “. . . line”, “. . . unit”, “. . . glass”, etc. described herein are used to process at least one function or operation, which may be implemented by hardware, software, or a combination of hardware and software.

Also, in the present disclosure, components are named using the first direction, the second direction, etc. to distinguish therebetween because the names of the components are the same, and the first direction and the second direction mean different directions (e.g., opposite directions) relative to each other.

Below, embodiments are described in detail with reference to the accompanying drawings, and in the description with reference to the accompanying drawings, the same or corresponding components are given the same reference numerals, and a redundant description thereof are omitted.

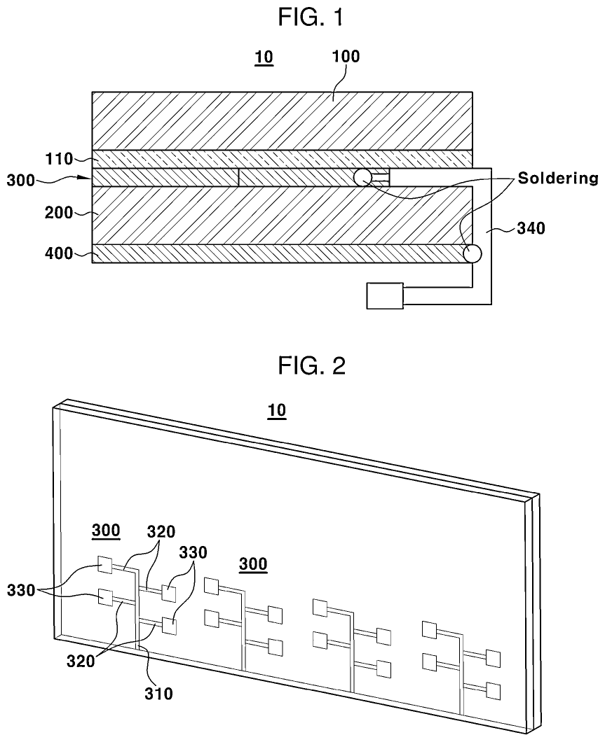

In one embodiment of the present disclosure, FIG. 1 illustrates a cross-sectional view of a windshield glass including a laminated glass antenna structure 10.

In this embodiment, the laminated glass antenna structure includes an upper glass 100, a lower glass 200, and a patch radiation unit 300 between the upper glass 100 and the lower glass 200. The patch radiation unit 300 includes a PVB film 110 (polyvinyl butyral film) which may be located on an upper surface, a lower surface or both surfaces of the patch radiation unit 300. The upper glass 100 and the lower glass 200 may be made of sodalime glass, and the upper glass 100 and the lower glass 200 may have the same thickness or different thicknesses.

The patch radiation unit 300 is located in at least a portion of the edge between the upper glass 100 and the lower glass 200. In another form of the present disclosure, the patch radiation unit 300 may be located at the upper or lower end of the windshield glass. Also, the patch radiation unit 300 may be configured to be electrically conductive with a ground 400 located on the rear surface of the lower glass 200.

Moreover, the patch radiation unit 300 is powered using a coaxial cable 340. The internal wire of the coaxial cable 340 is connected to a strip line 310 to transmit a signal, and the external wire thereof is connected to the ground 400 located on the rear surface of the lower glass 200.

In an embodiment of the present disclosure, the patch radiation unit 300, which is disposed between the lower glass 200 and the upper glass 100 and includes a plurality of quadrangular patch elements 330 at the ends of the tree shape, is designed to resonate at an operating frequency of 28 GHz. In the patch elements 330 of the patch radiation unit 300, the horizontal and vertical lengths and the permittivity of the upper glass 100 and the lower glass 200 act as design variables, and the plurality of patch elements 330 operates as an antenna due to the resonance of current between the patch radiation unit and the ground 400. Here, the size of the patch radiation unit 300 of the corresponding antenna is designed to maximize forward gain while resonating at 28 GHz.

Moreover, the patch radiation unit 300 of the present disclosure is provided in order to perform beam steering with high gain characteristics. The patch elements 330 are located not only to increase the gain but also so as to avoid offsetting the phase value of the resonant current.

Moreover, the strip line 310 has a width determined in comparison with the size of the patch elements 330, and is configured such that the patch radiation unit 300 resonates with the phase value of the current.

In an embodiment of the present disclosure, the antenna composed of the patch radiation unit 300 is arranged between the glass layers in the laminated glass antenna structure 10, and the principle of a superstrate antenna is applied to the laminated glass antenna structure 10. The application of principle of the superstrate antenna increases the radiation gain of the antenna by placing a dielectric material having high permittivity on the antenna radiation surface. In one form, a substrate having permittivity, including the upper glass 100 performing the function of a superstrate, is placed on the patch radiation unit 300, and radio waves emitted from the patch radiation unit 300 are reflected once more between the ground 400 located on the rear surface of the lower glass 200 and the upper glass 100, so a phase front is created to thereby improve the gain.

In an embodiment of the present disclosure, the patch radiation unit 300 is designed to resonate at 28 GHz, and when the upper glass 100 and the lower glass 200 have a relative permittivity (F/m) of 7, the thickness of the upper glass 100 may be from 1.5 mm to 2.7 mm and the thickness of the lower glass 200 may be from 0.3 mm to 1.1 mm.

Accordingly, the upper glass 100 functions as a superstrate having high permittivity and is located on the upper surface of the printed patch radiation unit 300, thereby further increasing the gain. The thickness of the upper glass 100 is set such that the characteristics of the superstrate may appear in consideration of the resonant frequency and size of the patch radiation unit 300. The upper glass 100 functions as a superstrate, and the current supplied from the patch elements 330 has the same frequency as the frequency of the patch radiation unit 300 through the upper glass 100, so forward gain may be increased.

The printed patch radiation unit 300 is located in at least a portion between the PVB film and the lower glass 200, and the ground 400 side of the patch radiation unit 300 is located at the lowermost end of the lower glass 200. Accordingly, the lower glass 200 operates as a substrate of the patch radiation unit 300. Here, the thickness of the lower glass 200 functioning as a substrate is considered an important variable in the design of the patch radiation unit and the micro strip line 310. Thus, in the case in which the lower glass 200 is too thick, it is difficult for the strip line 310, the extension lines 320, and the patch elements 330 located at the ends of the extension lines 320 to operate as the antenna. Taking into consideration of the high permittivity of a vehicle glass, an appropriate glass thickness to operate as a substrate is applied. In order to satisfy this thickness condition, it is ideal that the ratio of the width (length in the second direction) of the strip line 310 to the thickness of the substrate is set to be 1 or more. In the case in which the substrate becomes thick and the ratio is thus lowered to 0.5 or less, it is difficult to maintain sufficient forward gain.

Accordingly, in an embodiment of the present disclosure, the strip line 310 may have a width of from 0.1 mm to 0.9 mm, and the thickness of the lower glass 200 may be set to from 0.3 mm to 1.1 mm.

When powering the patch radiation unit 300 in a vehicle, the feed pin of the feed port of the patch radiation unit 300 is soldered to the micro strip line (strip line 310 or/and extension lines 320) of the patch radiation unit 300, and the ground 400 is soldered to the ground 400 side of the patch radiation unit 300. Moreover, in an embodiment of the present disclosure, the patch radiation unit 300 of the laminated glass antenna structure 10 is not directly connected to the upper glass 100, but is located under the PVB film so as to maximize forward gain.

The extension lines 320 may be configured such that an interval to the sequentially arranged patch elements 330 has a length corresponding to about a half wavelength of the resonant frequency. In one form, the distance between the patch elements 330 located at both sides of the strip line 310 is configured to have substantially the same length as one wavelength of a transmitted and received 5G mmWave (28 GHz). Thereby, high radiation gain may be obtained through the distance between patch elements 330 adjacent to each other at left and right sides equal to the phase of the current.

The laminated glass antenna structure 10 of the present disclosure is configured such that the patch radiation unit 300 disposed between the pieces of laminated glass serves as an antenna, and furthermore, by using the ground 400 located on the rear surface of the lower glass 200 and the upper glass 100 as a superstrate, all radio waves passing through the upper glass 100 have the same phase.

FIG. 2 illustrates a perspective view of a vehicle glass including the laminated glass antenna structure 10 according to an embodiment of the present disclosure.

With regard to the illustration, it includes at least one patch radiation unit 300 located at a portion of the lower end of the glass, and one or more patch radiation units 300 are located adjacent to each other in the width direction of the glass.

Each patch radiation unit 300 includes a strip line 310 extending in the height direction from the lower end of the glass and extension lines 320 extending in the lateral direction of the strip line 310. The ends of the extension lines 320 are provided with the patch elements 330. The extension lines 320 are alternately located at different heights on both sides of the strip line 310. In one form, the extension lines 320 include a first-direction extension line 321a extending rightwards from the strip line 310 and a second-direction extension line 322a located above the first-direction extension line 321a and extending leftwards from the strip line 310. At least one first-direction extension line 321a and at least one second-direction extension line 322a may be provided along the height of the strip line 310.

In an embodiment of the present disclosure, two first-direction extension lines 321a, 321b are formed along the height of the strip line 310, and two second-direction extension lines 322a, 322b are also arranged along the height of the strip line 310. Furthermore, the first-direction extension lines 321a, 321b and the second-direction extension lines 322a, 322b are sequentially located, and the first-direction extension lines 321 and the second-direction extension lines 322 are located in the height direction of the strip line 310 in the same number.

In an embodiment including four patch elements 330, the lower first-direction extension line 321a extends in the rightward direction in the drawing adjacent to the lower end of the strip line 310, and the lower second-direction extension line 322a is spaced apart by a predetermined interval at a position above the lower first-direction extension line 321a in the height direction of the strip line 310 and extends leftwards when viewed in cross section. In addition, the extension lines 320 are configured to be the same length as each other. The upper second-direction extension line 322b is configured to extend leftwards when viewed in cross section at a position above the upper first-direction extension line 321b.

In an embodiment including two patch elements 330 at respective sides, the lower first-direction extension line 321a, the upper first-direction extension line 321b, the lower second-direction extension line 322a, and the upper second-direction extension line 322b are configured to be spaced apart from each other at the same interval in the height direction, and are alternately located at different heights on opposite sides of the strip line 310 so as to extend in opposite directions. In another form, distances in the height direction between the first-direction extension lines 321a, 321b and the adjacent second-direction extension lines 322a, 322b may be set to be the same as each other.

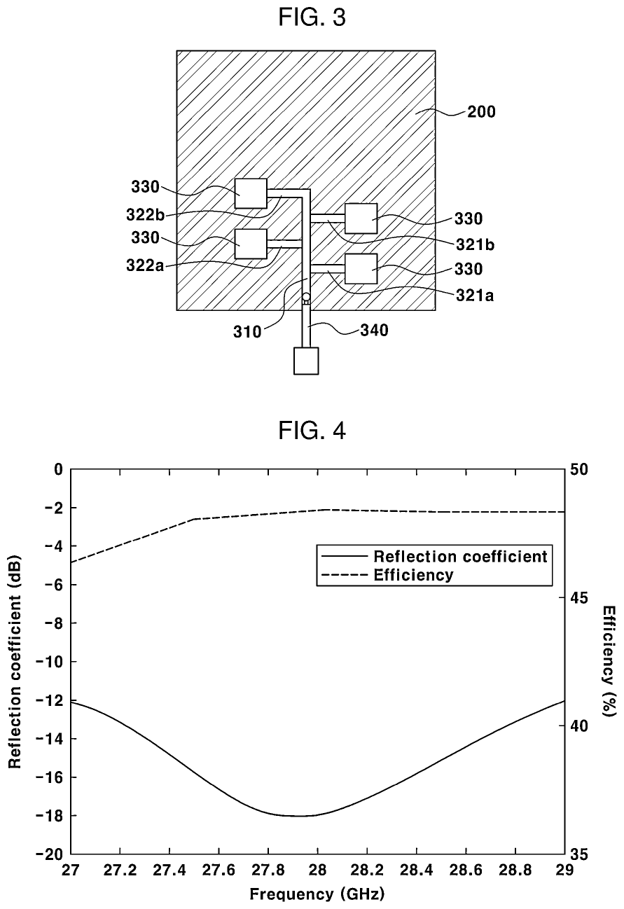

FIG. 3 illustrates an enlarged view of a single patch radiation unit 300 according to an embodiment of the present disclosure.

In one form, the patch radiation unit 300 is disposed between the upper glass 100 and the lower glass 200 and includes a first-direction extension line 320 and a second-direction extension line 320 extending rightwards and leftwards from the strip line 310 in the height direction. In another embodiment of the present disclosure, two first-direction extension lines 320 and two second-direction extension lines 320 are included in the patch radiation unit 300, and a patch element 330 is provided at the end of each extension line 320.

In the disclosed embodiment, the patch element 330 has a square cross section, and each side of the patch element 330 may be form 1.4 mm to 2.6 mm long.

In addition, the extension lines 320 are located in the height direction of the strip line 310 and have a width of from 0.1 mm to 0.9 mm, and the extension lines 320 may be configured to have a length of from 2.4 mm to 3.6 mm in the width direction from the strip line 310.

In one form, in order to provide a superstrate antenna structure, the upper glass 100 has a relative permittivity of from 6.8 to 7.1, and the thickness of the upper glass 100 is from 1.5 mm to 2.7 mm. Also, the lower glass 200 has the same relative permittivity as the upper glass 100, and the thickness thereof may be from 0.3 mm to 1.1 mm.

FIG. 4 illustrates the results of measurement of the reflection coefficient and efficiency of the glass according to an embodiment of the present disclosure including the upper glass 100 having a thickness of 2.1 mm, the lower glass 200 having a thickness of 0.7 mm, and the patch radiation unit 300 in which the length of each side of the patch elements 330 is 2 mm, the width of the strip line 310 is 0.5 mm, the length of the extension lines 320 is 3.6 mm, and the patch elements 330 are spaced apart from each other by a distance of 4.2 mm in the height direction.

Here, the reflection coefficient is a coefficient in which, when a signal is applied to the antenna (patch radiation unit 300) from a system including a feed line, the applied signal is not transmitted to the antenna but is reflected back.

Based on the dB scale data shown in FIG. 4, a reflection coefficient of −10 dB or less means that 90% or more of the power is transferred to the antenna from the system. Therefore, it can be confirmed that a reflection coefficient of −10 dB or less indicates superior performance of the antenna in the corresponding frequency range.

“Efficiency” means the ratio at which the signal transmitted to the antenna is radiated to the atmosphere in the form of electromagnetic waves, without being converted into heat or other energy, due to the material characteristics of glass or the structural characteristics of the antenna. An efficiency of 0 (0%) means that no electromagnetic waves are radiated to the atmosphere, and an efficiency of 1 (100%) means that all of the power applied to the antenna is radiated to the atmosphere in the form of electromagnetic waves.

The laminated glass antenna structure 10 according to the above embodiment may be configured such that the multilayered glass antenna for a vehicle has a reflection coefficient of −17.9 dB and an efficiency of 48.5% at a frequency of 28 GHz. This shows that the reflection efficiency of the patch radiation unit 300 (antenna) applied to the laminated glass is excellent.

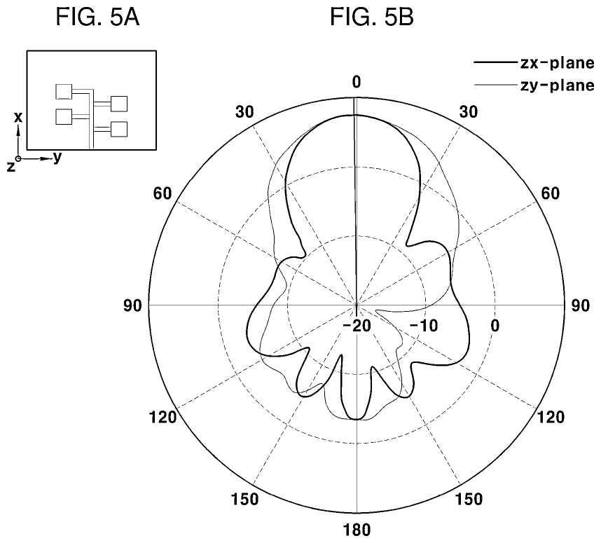

FIGS. 5A and 5B illustrate a radiation pattern in the zx and zy directions of an antenna on a glass plane according to an embodiment of the present disclosure. The patch radiation unit 300 (antenna) applied to the laminated glass for a vehicle has a narrow beam width so that the radiation direction of the patch radiation unit 300 may be steered in a desired direction. Therefore, by steering the radiation direction of the patch radiation unit 300 in a predetermined direction, it is possible to concentrate the radiation pattern at a position efficient for communication. The radiation direction of the patch radiation unit 300 is determined according to an embodiment of the present disclosure illustrated in FIGS. 1 to 3. The gain of the antenna is expressed in dBi, which means that power is transferred in a specific direction at a certain magnification compared to an ideal isotropic antenna.

As illustrated in FIGS. 5A and 5B, the patch radiation unit 300 applied to the laminated glass for a vehicle has a forward gain of 7.7 dBi at a frequency of 28 GHz. This means that a maximum of 4 times or more power is transferred compared to an isotropic antenna in a direction perpendicular to the flat plate of the antenna. Here, “isotropic antenna” means an ideal antenna that radiates the same power in all directions, that is, an antenna having a gain of 0 dBi in all directions.

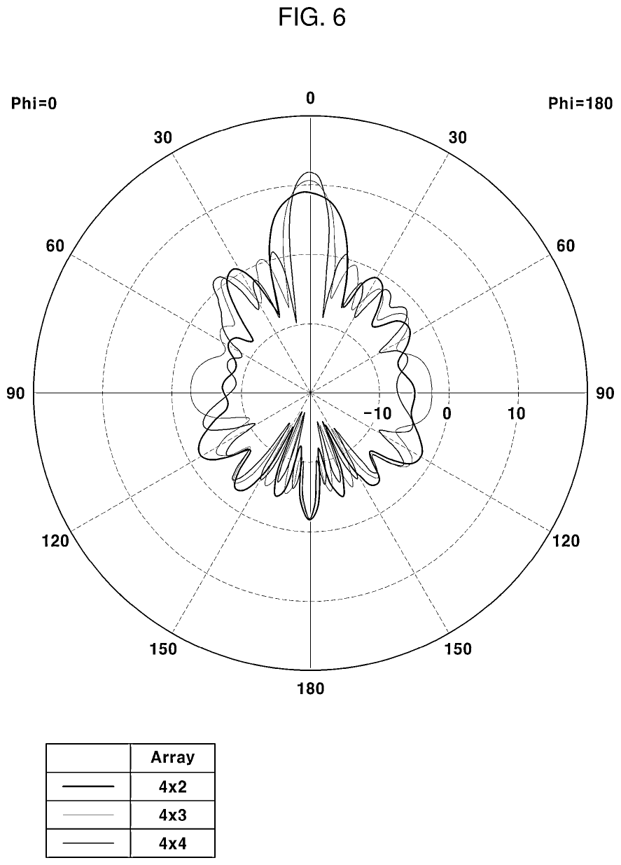

FIG. 6 illustrates the forward gain of the laminated glass antenna structure 10 including a plurality of tree-shaped patch radiation units 300 according to an embodiment of the present disclosure.

Referring to FIG. 6, the antenna configuration of the patch radiation units 300 having a tree structure and arranged in four rows shows that the forward gain value is large compared to patch radiation units 300 in two or three rows. In this embodiment, as the number of rows of patch radiation units 300 increases, the forward gain increases, but the beam width becomes narrower. Accordingly, the patch radiation units 300 are provided in multiple rows in order to increase the forward gain, and the gain for a narrow beam can be increased when an in-vehicle receiver using a specific terminal is provided.

As is apparent from the above description, the present disclosure can exhibit the following effects through the configuration, combination, and use relationship described herein.

According to the present disclosure, a very safe antenna structure can be provided only at a predetermined position between the pieces of glass because it includes elements arranged in a tree structure between the upper glass and the lower glass and a transmission line connecting the elements.

In addition, according to the present disclosure, an optimized single patch radiation unit can be provided, thereby effectively realizing an antenna in which the phase values of resonant current in the patch radiation unit can be matched.

The above detailed description is illustrative of the present disclosure. In addition, the above description shows and describes some embodiments of the present disclosure, and the present disclosure can be used in various other combinations, modifications, and environments. Specifically, changes or modifications are possible within the scope of the concept of the present disclosure, the scope equivalent to the described disclosure, and/or the scope of skill or knowledge in the art. The embodiments disclosed herein set forth the best mode for implementing the technical idea of the present disclosure, and various changes required for specific applications and uses of the present disclosure are possible. Accordingly, the detailed description of the present disclosure is not intended to limit the present disclosure to the disclosed embodiments.

What is claimed is:

1. A laminated glass antenna structure, comprising:
an upper glass located in a vehicle;
a patch radiation unit located in a portion of a rear surface of the upper glass; and
a lower glass located on a rear surface of the patch radiation unit,
wherein the patch radiation unit comprises:
a strip line located in a height direction of the patch radiation unit;
at least one extension line extending in a lateral direction of the strip line; and
a patch element located at an end of the at least one extension line.

2. The laminated glass antenna structure of claim 1, wherein the patch element has a quadrangular shape, each side of which is from 1.4 mm to 2.6 mm long.

3. The laminated glass antenna structure of claim 1, wherein the strip line has a width of from 0.1 mm to 0.9 mm.

4. The laminated glass antenna structure of claim 1, wherein the at least one extension line has a length of from 2.4 mm to 3.6 mm.

5. The laminated glass antenna structure of claim 1, further comprising a ground on a rear surface of the lower glass.

6. The laminated glass antenna structure of claim 1, wherein the upper glass has a thickness of from 1.5 mm to 2.7 mm.

7. The laminated glass antenna structure of claim 1, wherein the lower glass has a thickness of from 0.3 mm to 1.1 mm.

8. The laminated glass antenna structure of claim 1, wherein the patch radiation unit is provided in four rows in a width direction.
